(19) United States
(12) Patent Application Publication
(10) Pub. No.: US 2025/0333016 A1
(43) Pub. Date: Oct. 30, 2025

(54) BUMPER RETAINER AND ATTACHMENT STRUCTURE FOR VEHICLE COMPONENT

(71) Applicant: NIFCO INC., Yokosuka-shi, Kanagawa (JP)

(72) Inventors: Naofumi YAGAME, Yokosuka-shi, Kanagawa (JP); Hitoshi SUEHIRO, Toyota-shi, Aichi (JP)

(21) Appl. No.: 18/867,806

(22) PCT Filed: Jun. 29, 2023
(86) PCT No.: PCT/JP2023/024289

§ 371 Date: Nov. 21, 2024

(30) Foreign Application Priority Data
Jun. 30, 2022 (JP) 2022-106681

(51) Int. Cl. B60R 19/48

(52) U.S. Cl. CPC B60R 19/483

(57) ABSTRACT

A bumper retainer includes a retainer main body for attaching a bumper to a vehicle body, the retainer main body being made of resin; a sensor attachment part provided on a side in a thickness direction of the retainer main body, the sensor attachment part being integral with or separate from the retainer main body, the sensor attachment part enabling a sensor to be attached to the sensor attachment part; and a connection part protruding from the retainer main body in a direction orthogonal to the thickness direction, the connection part being located on a straight line extending in the thickness direction through the sensor attachment part as viewed counter to the direction in which the connection part protrudes, the connection part being separate from the sensor attachment part, and connectable to an exterior component.

### FIELD

The present disclosure relates to a bumper retainer and an attachment structure for a vehicle component.

### BACKGROUND

Japanese Patent No. 4285434 discloses a bumper retainer that is made of resin and allows a rear bumper to be attached to a rear fender of a vehicle body. A rear lamp is disposed above the bumper retainer, and an engagement hook integrally molded with the bumper retainer engages with a hook receiving part of the rear lamp.

Japanese Patent No. 6254183 discloses a bumper retainer for attaching a bumper to a vehicle body. The bumper retainer is provided with a radar mount that bears a vehicle radar.

### SUMMARY OF THE INVENTION

### Technical Problem to Be Solved by the Invention

Techniques have been examined for providing a sensor attachment part as a radar mount to a bumper retainer to be connected to a rear lamp as an exterior component. However, in a case where a sensor attachment part is integrally molded with a bumper retainer, because of the direction of demolding, it is necessary to change the position of a connection part to be connected to an exterior component. In a case where the position of the connection part is changed in consideration of demolding, the bumper retainer is likely to increase in size.

In an aspect of the present disclosure, an object is to provide a technique that can suppress an increase in the size of a retainer main body of a bumper retainer for attaching a bumper to a vehicle body, as compared with a retainer main body integral with a sensor attachment part and a connection part.

### Solution to Problem

According to an aspect of the present disclosure, a bumper retainer comprises a retainer main body for attaching a bumper to a vehicle body, the retainer main body being made of resin; a sensor attachment part provided on a side in a thickness direction of the retainer main body, the sensor attachment part being integral with or separate from the retainer main body, the sensor attachment part enabling a sensor to be attached to the sensor attachment part; and a connection part protruding from the retainer main body in a direction orthogonal to the thickness direction, the connection part being located on a straight line extending in the thickness direction through the sensor attachment part as viewed counter to the direction in which the connection part protrudes, the connection part being separate from the sensor attachment part, the connection part being connectable to an exterior component.

According to another aspect of the present disclosure, an attachment structure for vehicle components comprises a vehicle body; a bumper retainer attached to the vehicle body; a bumper attached to the bumper retainer; a sensor attached to the bumper retainer; and an exterior component attached to the vehicle body, the exterior component being connected to the bumper retainer, in which the bumper retainer comprises a retainer main body for attaching the bumper to the vehicle body, the retainer main body being made of resin; a sensor attachment part provided on a side opposite to a side of the vehicle body in a thickness direction of the retainer main body, the sensor attachment part being integral with or separate from the retainer main body, the sensor being attached to the sensor attachment part; and a connection part protruding from the retainer main body in a direction orthogonal to the thickness direction, the connection part being located on a straight line extending in the thickness direction through the sensor attachment part as viewed counter to the direction in which the connection part protrudes, the connection part being separate from the sensor attachment part and connected with the exterior component.

Note that the thickness direction of the retainer main body is identical to the direction of opening and closing of a pair of molds for molding the retainer main body.

### Advantageous Effects of Invention

According to an aspect of the present disclosure, it is possible to provide a technique that can suppress an increase in the size of a retainer main body of the bumper retainer for attaching the bumper to the vehicle body, as compared with a retainer main body integral with a sensor attachment part and a connection part.

### BRIEF DESCRIPTION OF DRAWINGS

FIG. 1 is a perspective view illustrating an

attachment structure for a vehicle component and a bumper retainer according to an embodiment of the present disclosure.

FIG. 2 is a horizontally sectional view of the attachment structure for a vehicle component and the bumper retainer illustrated in FIG. 1.

FIG. 3 is a longitudinal section of the periphery of a connection part between an exterior component and the bumper retainer illustrated in FIG. 1.

FIG. 4 is a plan view of the bumper retainer illustrated in FIG. 1.

FIG. 5 is an enlarged view of an area indicated by an arrow 5X of FIG. 4.

FIG. 6 is a sectional view taken along line 6X-6X of FIG. 4.

FIG. 7 is a perspective view of the front side of a retainer main body before a clip is attached to the retainer main body.

FIG. 8 is a perspective view of the rear side of the retainer main body before the clip is attached to the retainer main body.

FIG. 9 is a perspective view of the front side of the retainer main body with the clip attached to the retainer main body.

FIG. 10 is a perspective view of the rear side of the retainer main body with the clip attached to the retainer main body.

FIG. 11 is a perspective view of the clip.

FIG. 12 is a plan view of the clip.

FIG. 13 is a side view of the clip.

FIG. 14 is a side view of the clip that is orthogonal to the side view of FIG. 13.

FIG. 15 is an enlarged plan view of an opening of the retainer main body.

FIG. 16 is an enlarged plan view illustrating a state where an insertion part of the clip is inserted in the opening of the retainer main body illustrated in FIG. 15.

FIG. 17 is a perspective view of the front side of a retainer main body of a bumper retainer according to another embodiment of the present disclosure before a housing case is attached to the retainer main body.

FIG. 18 is a perspective view of the rear side of the retainer main body, illustrated in FIG. 17, before the housing case is attached to the retainer main body.

FIG. 19 is a perspective view of the front side of the retainer main body, illustrated in FIG. 17, with the housing case attached to the retainer main body.

FIG. 20 is a perspective view of the rear side of the retainer main body, illustrated in FIG. 18, with the housing case attached to the retainer main body.

### DESCRIPTION OF EMBODIMENTS

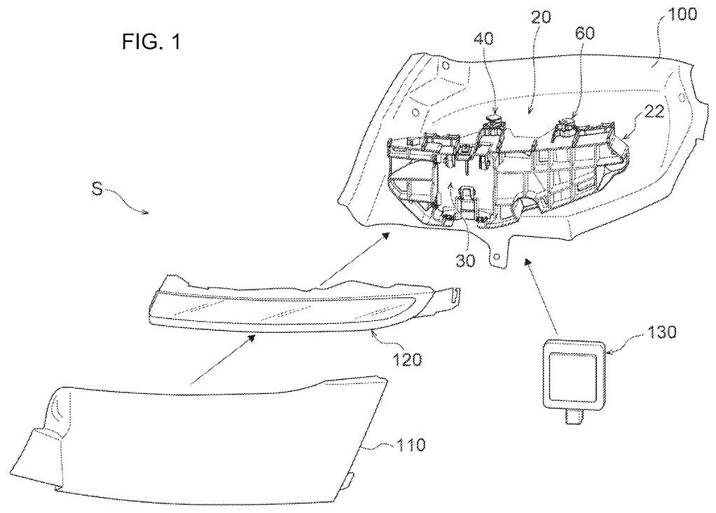

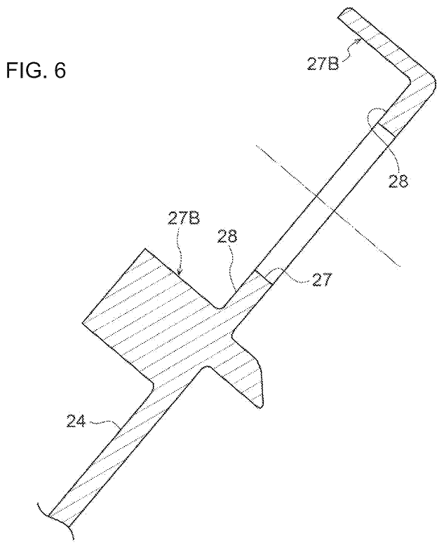

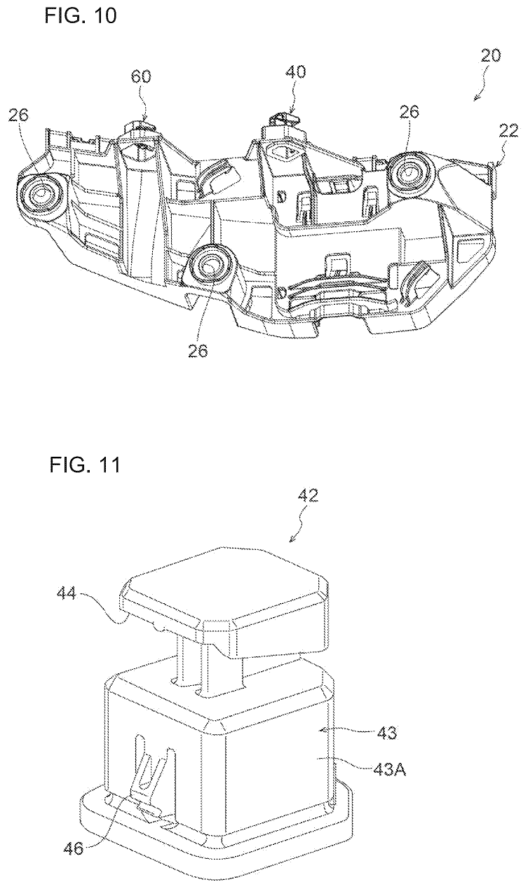

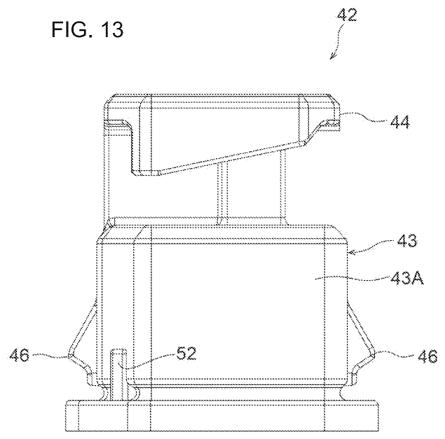

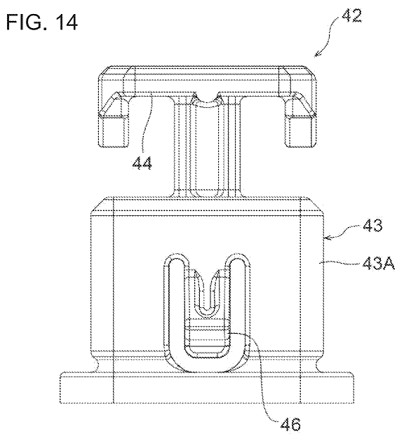

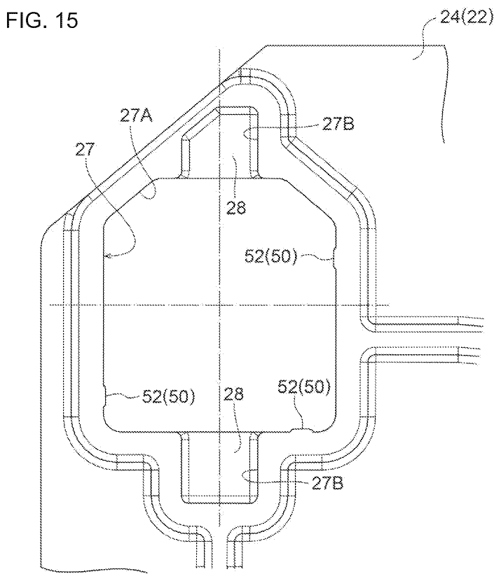

A bumper retainer and an attachment structure for a vehicle component according to an embodiment of the present disclosure will be described with FIGS. 1 to 16.

### Bumper Retainer

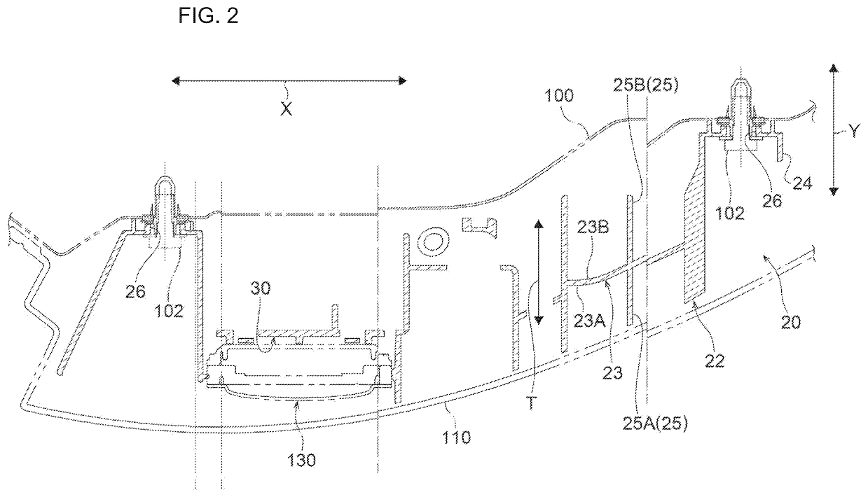

As illustrated in FIGS. 1 and 2, a bumper retainer 20 (hereinafter, simply referred to as “retainer 20”) according to the present embodiment serves as a member used for attaching a bumper 110 to a vehicle body (e.g., a body panel) 100. Note that the bumper 110 is an exemplary vehicle component in the present disclosure.

As illustrated in FIG. 2, the retainer 20 according to the present embodiment is used for attaching the bumper 110 to a rear fender of the vehicle body 100. Note that the bumper 110 according to the present embodiment corresponds to a rear bumper.

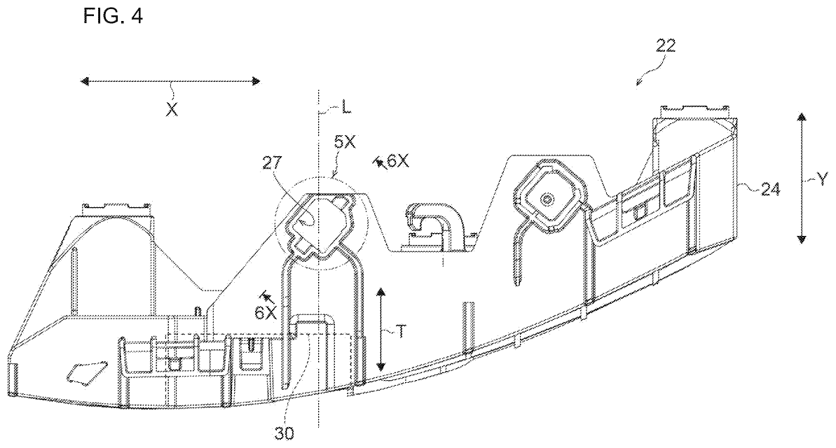

As illustrated in FIG. 4, the retainer 20 includes a retainer main body 22, a sensor attachment part 30, and a first connection part 40 as a connection part.

### Retainer Main Body

As illustrated in FIGS. 2 and 4, the retainer main body 22 serves as a member with which the main body of the retainer 20 is achieved. The bumper 110 is attached to the vehicle body 100 through the retainer main body 22 (refer to FIG. 1). The retainer main body 22 is made of resin.

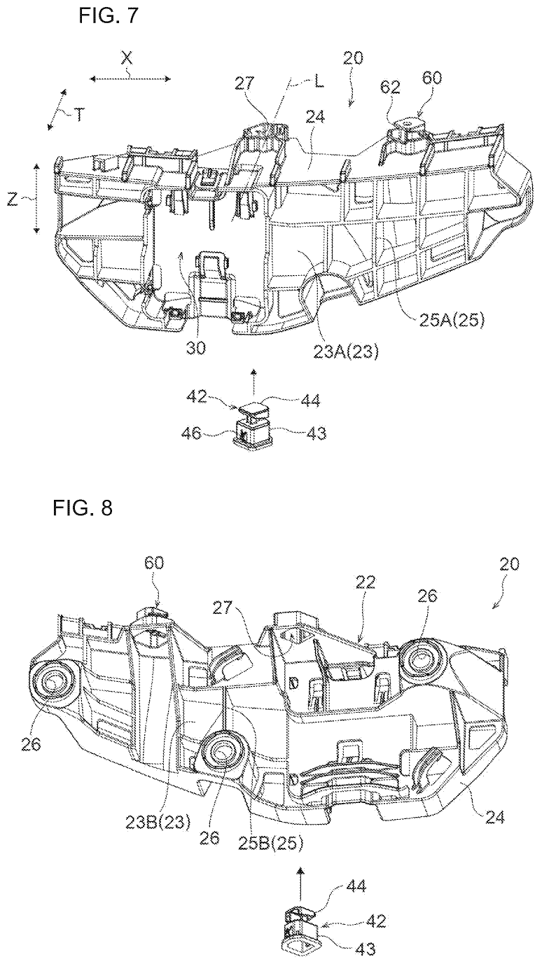

Note that, in FIGS. 2 and 4, a double-headed arrow X indicates the longitudinal direction of the retainer main body 22, and a double-headed arrow Y indicates the lateral direction of the retainer main body 22. A double-headed arrow Z (refer to FIG. 7) indicates the height direction of the retainer main body 22 (hereinafter, simply referred to as “retainer height direction”). Note that the lateral direction of the retainer main body 22 may be paraphrased as the depth direction. A double-headed arrow T indicates the thickness direction of the retainer main body 22. Here, the thickness direction of the retainer main body 22 (hereinafter, simply referred to as “retainer thickness direction”) is identical to the direction of opening and shutting of a pair of molds for molding the retainer main body 22 (including the direction of demolding). Note that, in the present embodiment, the lateral direction of the retainer main body 22 and the retainer thickness direction are identical to each other. The retainer thickness direction and the retainer height direction are orthogonal to each other.

As illustrated in FIGS. 2, 7, and 8, the retainer main body 22 includes a plate-shaped part 23, a peripheral wall part 24 formed along the outer periphery of the plate-shaped part 23, and reinforcing ribs 25 provided to both a front face 23A and a rear face 23B of the plate-shaped part 23.

As illustrated in FIGS. 2 and 7, the plate-shaped part 23 is provided with the sensor attachment part 30. Specifically, the sensor attachment part 30 is provided on the front face 23A side of the plate-shaped part 23. Note that the sensor attachment part 30 will be described in detail later.

The plate-shaped part 23 is provided with attachment holes 26 for attaching the retainer main body 22 to the vehicle body 100 through clips 102. The attachment holes 26 penetrate through the plate-shaped part 23 in the retainer thickness direction. Note that, in the present embodiment, the number of attachment holes 26 provided to the plate-shaped part 23 is three, but the present discloser is not limited to this. Thus, the number of attachment holes 26 may be two or less or four or more.

As illustrated in FIGS. 7 and 8, the peripheral wall part 24 serves as a wall part projecting along the retainer thickness direction from a peripheral edge of the plate-shaped part 23. Note that the peripheral wall part 24 may project from the peripheral edge of the plate-shaped part 23 to both sides or only one side in the retainer thickness direction. The peripheral wall part 24 may have a uniform or non-uniform projecting height. Furthermore, the peripheral wall part 24 may be formed continuously or non-continuously along the peripheral edge of the plate-shaped part 23.

As illustrated in FIGS. 7 and 8, the reinforcing ribs 25 are provided to both the front face 23A and the rear face 23B of the plate-shaped part 23. Specifically, the reinforcing rib 25 includes a first reinforcing rib 25A protruding in the retainer thickness direction from the front face 23A of the plate-shaped part 23 and a second reinforcing rib 25B protruding in the retainer thickness direction from the rear face 23B of the plate-shaped part 23. Note that, hereinafter, the direction in which the first reinforcing rib 25A protrudes from the front face 23A of the plate-shaped part 23 is referred to as one side in the retainer thickness direction. The direction in which the second reinforcing rib 25B protrudes from the rear face 23B of the plate-shaped part 23 is referred to as the other side in the retainer thickness direction.

The front face 23A of the plate-shaped part 23 is provided with a plurality of the first reinforcing ribs 25A. The first reinforcing ribs 25A on the front face 23A may be identical to or different from each other in protruding height. Furthermore, one of the first reinforcing ribs 25A may have a uniform or non-uniform protruding height in its longitudinal direction.

The rear face 23B of the plate-shaped part 23 is provided with a plurality of the second reinforcing ribs 25B. The second reinforcing ribs 25B on the rear face 23B may be identical to or different from each other in protruding height. Furthermore, one of the second reinforcing ribs 25B may have a uniform or non-uniform protruding height in its longitudinal direction.

As illustrated in FIGS. 4 to 6, the retainer main body 22 is provided with an opening 27 into which a clip 42, described later, is inserted. Specifically, the opening 27 is provided to a portion that is a part of the peripheral wall part 24 of the retainer main body 22 and is located on the other side in the retainer thickness direction of the plate-shaped part 23 and on the upper side in the height direction of the retainer main body 22. The opening 27 serves as a through hole penetrating through the peripheral wall part 24 in the height direction of the retainer main body 22. Note that, with the clip 42 inserted in the opening 27, a part of the clip 42 protrudes upward from the peripheral wall part 24 in the retainer height direction orthogonal to the retainer thickness direction. The clip 42 is located on a straight line L extending in the retainer thickness direction through the sensor attachment part 30 as viewed counter to the direction in which the clip 42 protrudes (here, as viewed from above in the retainer height direction). That is, the opening 27 is provided to the peripheral wall part 24 such that the clip 42 is located on the straight line L.

### Sensor Attachment Part

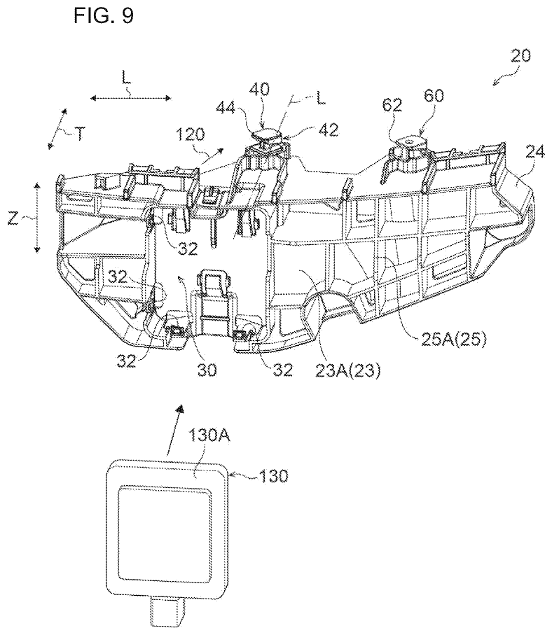

The sensor attachment part 30 serves as a part to which a sensor 130 can be attached, the part being provided to the retainer main body 22. As illustrated in FIGS. 7 and 9, the sensor attachment part 30 is provided on the one side in the thickness direction of the retainer main body 22.

Specifically, the sensor attachment part 30 is provided on the front face 23A side of the plate-shaped part 23. The sensor attachment part 30 corresponds to a recess into which the sensor 130 is fitted, the recess being provided to the front face 23A of the plate-shaped part 23. The sensor attachment part 30 is provided with a plurality of locking claws 32 that inhibit the fitted sensor 130 from coming off. The locking claws 32 are caught on a peripheral edge 130A of the sensor 130 to prevent the sensor 130 from coming off the sensor attachment part 30. Note that the sensor 130 used in the present embodiment serves as a radar sensor that detects an approaching object.

The sensor attachment part 30 is integral with the retainer main body 22. That is, the sensor attachment part 30 and the retainer main body 22 are an integrally molded resin product.

### Connection Parts

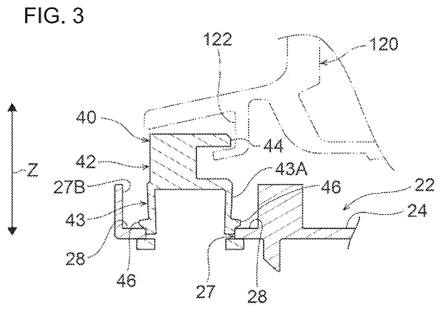

The first connection part 40 serves as a part enabling the retainer main body 22 to be connected to a rear lamp 120 as an exemplary exterior component (a rear combination lamp in the present embodiment). As illustrated in FIGS. 3, 9, and 10, the first connection part 40 protrudes upward, in the retainer height direction orthogonal to the retainer thickness direction, from the peripheral wall part 24 of the retainer main body 22. The first connection part 40 is located on the straight line L extending in the retainer thickness direction through the sensor attachment part 30 as viewed counter to the direction in which the first connection part 40 protrudes (here, as viewed from above in the retainer height direction). In other words, the first connection part 40 is partially disposed in the region between the straight lines L passing one-to-one through both ends in a direction orthogonal to the retainer thickness direction of the sensor attachment part 30 as viewed counter to the direction in which the first connection part 40 protrudes.

The first connection part 40 is separate from the sensor attachment part 30 integral with the retainer main body 22 and is formed of the clip 42 as an exemplary connection member that connects the retainer main body 22 and the rear lamp 120. Specifically, the first connection part 40 is formed of a portion protruding from the opening 27 with the clip 42 inserted in the opening 27 of the retainer main body 22.

As illustrated in FIGS. 7, 8, and 11, the clip 42 includes a hook part 44 as an exemplary locking part to mate with a hook receiving part 122 as an exemplary part to be mated with, included in the rear lamp 120. The hook part 44 is provided to the leading end in the protruding direction of the clip 42 and is caught on the hook-part receiving part 122 to connect the retainer main body 22 and the rear lamp 120.

As illustrated in FIGS. 11 to 14, the clip 42 includes an insertion part 43 that serves as a part to be inserted into the opening 27 and is provided with engagement claws 46 each serving as an exemplary engagement part to engage with a step 28 as an exemplary part to be engaged with, included in the retainer main body 22. Specifically, the opening 27 of the peripheral wall part 24 has an inner peripheral face 27A provided with grooves 27B extending, at mutually opposed positions, from the outer face toward the inner face of the peripheral wall part 24. The grooves 27B terminate short of the inner face of the peripheral wall part 24. Due to the termination of each groove 27B, a step 28 is formed. The engagement claws 46 elastically deformable on the insertion part 43 of the clip 42 each engage with the corresponding step 28. The method of attaching the clip 42 to the retainer main body 22 by the engagement between the engagement claws 46 and the steps 28 is a so-called snap fit. Note that the method of attaching the clip 42 to the retainer main body 22 is not limited to such a snap fit.

The clip 42 is an integrally molded resin product. The clip 42 is molded by a mold different from a pair of molds for molding the retainer main body 22 and the sensor attachment part 30.

The retainer main body 22 is provided with a second connection part 60 that is located away from the first connection part 40 and enables the retainer main body 22 to be connected to the rear lamp 120. As illustrated in FIG. 7, the second connection part 60 protrudes upward, in the retainer height direction orthogonal to the retainer thickness direction, from the peripheral wall part 24 of the retainer main body 22. The second connection part 60 is spaced from the first connection part 40 in the longitudinal direction of the retainer main body 22 (refer to FIG. 9).

The second connection part 60 is integral with the retainer main body 22. That is, the second connection part 60 is integrally molded with the retainer main body 22 and the sensor attachment part 30. The second connection part 60 includes a hook part 62 to mate with a hook receiving part (not illustrated) included in the rear lamp 120. The hook part 62 is provided to the leading end in the protruding direction of the second connection part 60 and is caught on the hook-part receiving part (not illustrated) to connect the retainer main body 22 and the rear lamp 120. Note that, in the present embodiment, the retainer main body 22 and the rear lamp 120 are connected through the first connection part 40 and the second connection part 60, resulting in a stable connection between the retainer main body 22 and the rear lamp 120.

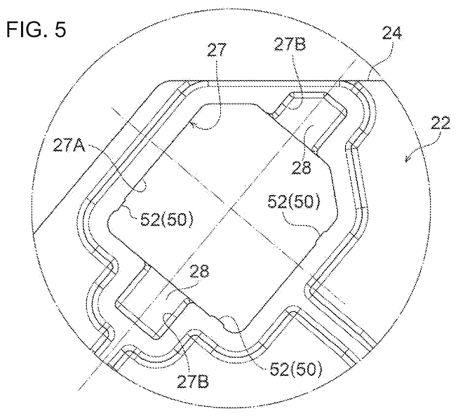

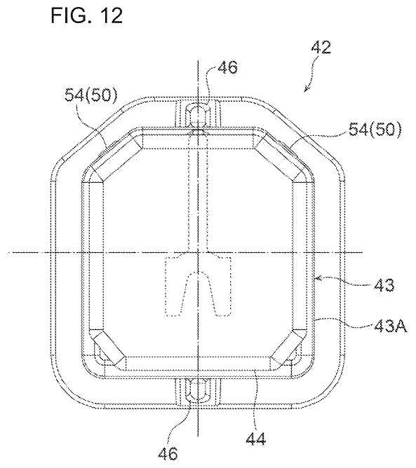

As illustrated in FIGS. 5 and 12, the retainer 20 includes a blocking mechanism 50 that prevents the clip 42 inserted in the opening 27 from rotating. Specifically, the blocking mechanism 50 prevents the clip 42 inserted in the opening 27 from rotating around the insertion direction of the clip 42. Note that, in the present embodiment, the insertion direction of the clip 42 (hereinafter, as appropriate, referred to as “clip insertion direction”) corresponds to a direction from bottom up along the retainer height direction.

The blocking mechanism 50 includes a first rib 52 and a second rib 54.

As illustrated in FIG. 5, a plurality of the first ribs 52 is provided, spaced apart in the circumferential direction, on the inner peripheral face 27A of the opening 27. The first ribs 52 protrude from the inner peripheral face 27A and extends along the clip insertion direction from one end toward the other end of the opening 27. Note that, in the present embodiment, the number of first ribs 52 provided to the inner peripheral face 27A of the opening 27 is three, but the present disclosure is not limited to this configuration.

As illustrated in FIG. 12, a plurality of the second ribs 54 is provided, spaced apart in the circumferential direction, on the outer peripheral face 43A of the insertion part 43 to be inserted into the opening 27, in the clip 42.

The second ribs 54 provided to a portion on the side counter to the clip insertion direction of the insertion part 43 protrude from the outer peripheral face 43A and extend along the clip insertion direction. Note that, in the present embodiment, the number of second ribs 54 provided to the outer peripheral face 43A of the insertion part 43 is two, but the present disclosure is not limited to this configuration.

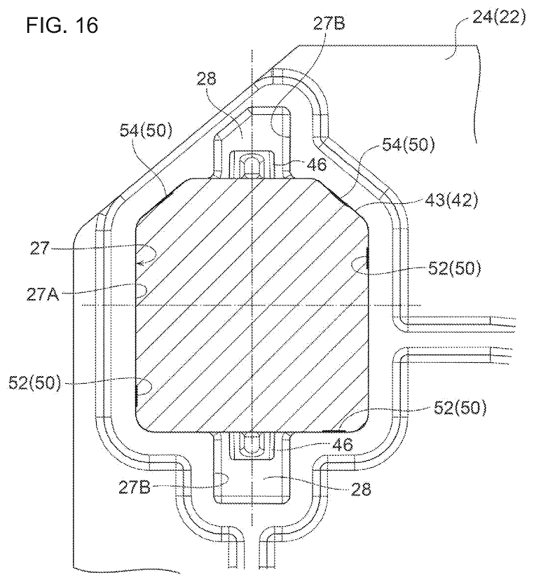

As illustrated in FIG. 16, with the clip 42 having the insertion part 43 inserted in the opening 27, the first ribs 52 are in contact with the outer peripheral face 43A of the insertion part 43, and the second ribs 54 are in contact with the inner peripheral face 27A of the opening 27.

As illustrated in FIG. 9, as the retainer 20 is viewed counter to the protruding direction of the first connection part 40, the direction in which the sensor 130 is attached to the sensor attachment part 30 is different from the direction in which the rear lamp 120 is connected to the first connection part 40. Specifically, the sensor attachment part 30 allows the sensor 130 to be attached thereto along the retainer thickness direction. Meanwhile, the first connection part 40 allows the rear lamp 120 to be connected thereto at an angle to the retainer thickness direction. That is, the direction in which the hook part 44 is caught on the hook receiving part 122 is oblique to the retainer thickness direction.

The retainer 20 is provided with an attachment part (not illustrated) to which the bumper 110 is attached. The attachment part may be a step part on which an elastic claw (not illustrated) provided to the bumper 110 is caught.

### Attachment Structure for Vehicle Component

As illustrated in FIGS. 1 and 2, an attachment structure S for a vehicle component according to the present embodiment corresponds to a structure for attaching the bumper 110 and the sensor 130 to the vehicle body 100 through the retainer 20. Specifically, the attachment structure S includes the vehicle body 100, the retainer 20 attached to the vehicle body 100, the bumper 110 attached to the retainer 20, the sensor 130 attached to the retainer 20, and the rear lamp 120 that is attached to the vehicle body 100 and is connected to the retainer 20.

In order to attach vehicle components (bumper 110 and sensor 130) to the vehicle body 100, first, the retainer main body 22 to which the clip 42 is attached is attached to the vehicle body 100 through the clips 102. Next, the sensor 130 is attached to the sensor attachment part 30, and the rear lamp 120 is connected to the first connection part 40 and the second connection part 60. Note that either the attachment of the sensor 130 or the connection of the rear lamp 120 may be performed first. After that, the bumper 110 is attached to the retainer main body 22. Thus, the bumper 110 and the sensor 130 are attached to the vehicle body 100 through the retainer 20.

Next, the functions and effects of the retainer 20 and the attachment structure S according to the present embodiment will be described.

In a case where the retainer main body 22, the sensor attachment part 30, and the first connection part 40 are integrally molded, mainly, a pair of molds for molding the retainer main body 22 and the sensor attachment part 30 and a slider for molding the first connection part 40 interfere with each other. Thus, as illustrated in FIG. 3, as the retainer main body 22 is viewed counter to the protruding direction of the first connection part 40, the first connection part 40 fails to be disposed on the straight line L passing through the sensor attachment part 30. In order to avoid the mutual interference between the molds and the slider, it is conceivable that the first connection part 40 is disposed at a position out of the straight line L. However, in this case, the size of the retainer main body is likely to increase. Changing the position of the first connection part 40 is likely to cause a change in the position of the hook receiving part 122 of the rear lamp 120 to which the first connection part 40 is connected. On the other hand, it is conceivable that a change is made in the position of the sensor attachment part 30 with no change in the position of the first connection part 40. However, the position of the sensor attachment part 30 depends on the attachment position of the sensor 130 to the vehicle body 100, and thus a change in position is difficult to be made.

Considering the above fact, in the retainer 20 according to the present embodiment, in a case where the retainer main body 22 and the sensor attachment part 30 are integral together, the first connection part 40 is separated from the sensor attachment part 30. That is, the first connection part 40 is separated from the retainer main body 22. In such a case where the first connection part 40 is separated from the retainer main body 22 and the sensor attachment part 30 as above, the first connection part 40 can be disposed by retrofitting (namely, after molding) on the straight line L passing through the sensor attachment part 30 as the retainer main body 22 is viewed counter to the protruding direction of the first connection part 40. Thus, in the retainer 20 according to the present embodiment, an increase in the size of the retainer main body 22 can be suppressed as compared with a case where the retainer main body 22, the sensor attachment part 30, and the first connection part 40 are integrated together. In this manner, an increase in the size of the retainer 20 is suppressed, enabling effective use of the space between the vehicle body 100 and the bumper 110.

In the retainer 20 according to the present embodiment, since the first connection part 40 is separated from the retainer main body 22 and the sensor attachment part 30, the first connection part 40 can be molded singly. Thus, the retainer 20 has a higher degree of freedom in the shape of the first connection part 40 than in a case where the first connection part 40 is integrally molded with other parts.

In the retainer 20 according to the present embodiment, the engagement claws 46 of the clip 42 separated from the retainer main body 22 engage with (or get caught on) the steps 28 of the retainer main body 22, so that the clip 42 is attached to the retainer main body 22. The hook part 44 of the clip 42 mates with (or gets caught on) the hook receiving part 122 of the rear lamp 120, so that the clip 42 and the rear lamp 120 are connected together. Here, in the retainer 20, since the clip 42 is separated from the retainer main body 22 and the sensor attachment part 30, the hook part 44 and the engagement claws 46 are easily molded on the clip 42.

In the retainer 20 according to the present embodiment, with the clip 42 inserted in the opening 27 of the retainer main body 22, the blocking mechanism 50 prevents the clip 42 from rotating to the opening 27. Thus, with the clip 42 inserted in the opening 27 of the retainer main body 22, backlash due to rotation of the clip 42 is prevented.

In the retainer 20 according to the present embodiment, when the insertion part 43 of the clip 42 is inserted into the opening 27 of the retainer main body 22, first, the first ribs 52 have contact with the outer peripheral face 43A of the insertion part 43. When the insertion part 43 is inserted into the opening 27 with the contact state being kept, the second ribs 54 of the insertion part 43 have contacted with the inner peripheral face 27A of the opening 27, leading to prevention of the clip 42 from rotating to the opening 27. Here, in the retainer 20, the clip 42 is inserted into the opening 27 and then is guided in the clip insertion direction inside the opening 27 by the first ribs 52 until the second ribs 54 have contacted with the inner peripheral face 27A of the opening 27. In this state, since the second ribs 54 of the clip 42 are out of contact with the inner peripheral face 27A of the opening 27, the insertion force to insert the clip 42 into the opening 27 can be kept low. That is, in the retainer 20, the clip 42 can be inserted into the opening 27 with a low insertion force at the beginning of insertion and the clip 42 can be effectively prevented from rotating to the opening 27 after insertion.

In the retainer 20 according to the present embodiment, since the sensor attachment part 30 and the first connection part 40 are separated from each other, optimum directions of demolding can be set for the sensor attachment part 30 and the first connection part 40. Thus, as viewed counter to the protruding direction of the first connection part 40, the direction in which the sensor 130 is attached to the sensor attachment part 30 and the direction in which the rear lamp 120 is connected to the first connection part 40 can be made different from each other. Thus, the attachment direction of the sensor 130 and the connection direction of the rear lamp 120 can be optimized.

The retainer 20 according to the present embodiment allows the bumper 110 serving as a rear bumper (vehicle component) to be attached to the vehicle body 100 through the retainer main body 22 attached to the vehicle body 100. The sensor 130 serving as a radar sensor (vehicle component) is attached to the sensor attachment part 30 provided to the retainer main body 22, so that the radar sensor is attached to the vehicle body 100. The radar sensor can detect, through the bumper 110, an object approaching the vehicle body 100 from its rear lateral side. The rear lamp 120 to be attached to the vehicle body 100 and the retainer main body 22 are connected through the first connection part 40 protruding from the retainer main body 22. Thus, the gap between the rear lamp 120 and the retainer main body 22 can be controlled. For example, a narrower gap between the rear lamp 120 and the retainer main body 22 improves appearance.

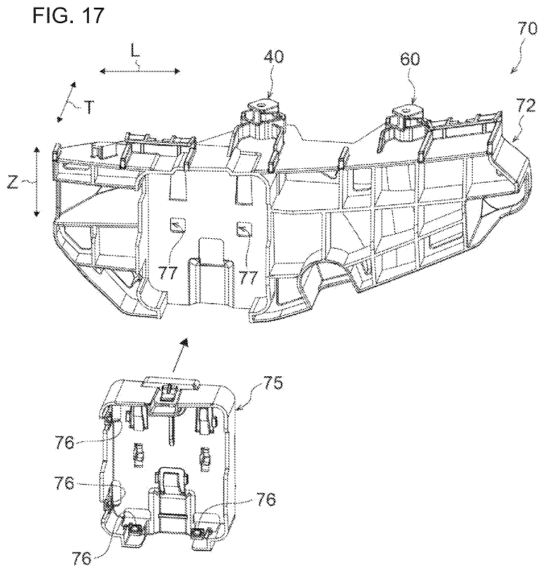

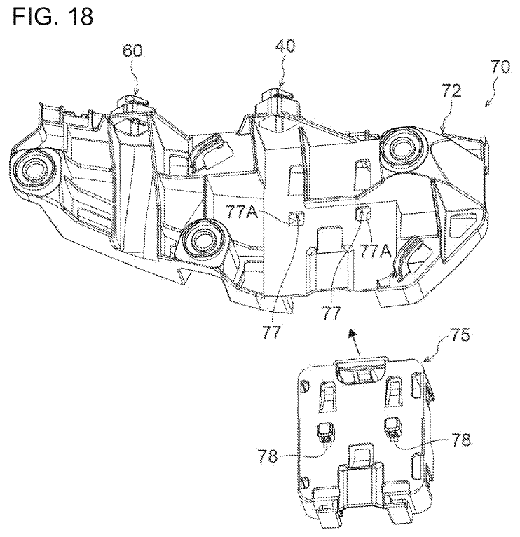

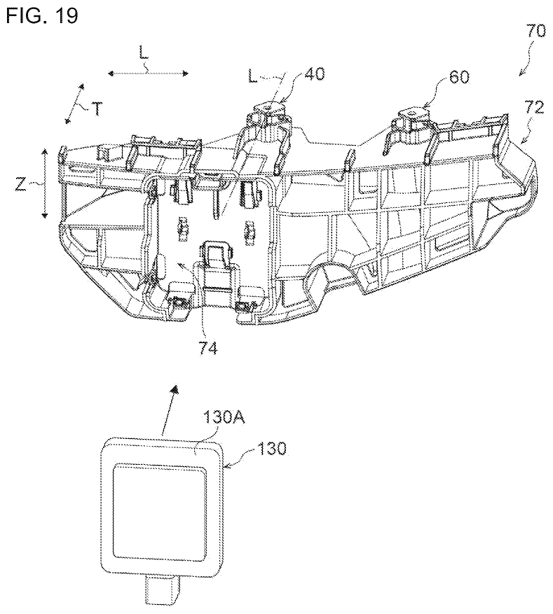

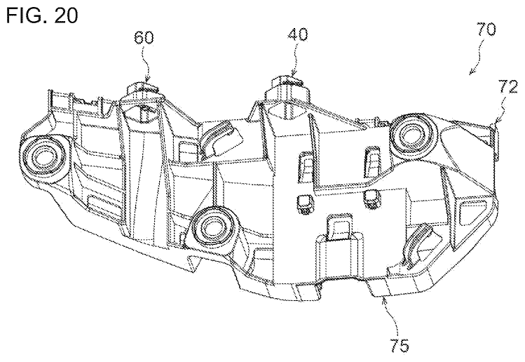

In the retainer 20 according to the above-described embodiment, the sensor attachment part 30 and the retainer main body 22 are integrated together and the first connection part 40 is separated from the sensor attachment part 30 and the retainer main body 22, but the present disclosure is not limited to this configuration. For example, as in the case of a retainer 70 illustrated in FIGS. 17 to 20, a sensor attachment part 74 may be separated from a retainer main body 72 and the first connection part 40, and the first connection part 40 may be integrated with the retainer main body 72. In the retainer 70, the sensor attachment part 74 is formed of a housing case 75 as an exemplary sensor attachment member that allows the sensor 130 to be attached to the retainer main body 72. The housing case 75 serves as a member that houses the sensor 130 and is secured by fitting to a recess formed in the retainer main body 72. Specifically, the housing case 75 includes locking claws 76 that are caught on the peripheral edge 130A (exemplary part to be mated with) of the sensor 130 to mate with (here, restrains) the sensor 130, and engagement claws 78 that are caught on edges 77A (exemplary parts to be engaged with) of through holes 77 provided to the bottom face of the recess of the retainer main body 72 to secure the housing case 75 to the retainer main body 72. Here, since the retainer main body 72 and the sensor attachment part 74 are separated from each other in the retainer 70, with the retainer main body 72 and the first connection part 40 being integrated together, the first connection part 40 can be set at a predetermined position. In such a case where the sensor attachment part 74 is separated from the retainer main body 72 as above, the housing case 75, with which the sensor attachment part 74 is formed, is fitted later to the retainer main body 72. Thus, an increase in the size of the retainer main body 72 can be suppressed as compared with a case where the retainer main body 72, the sensor attachment part 74, and the first connection part 40 are integral together. The sensor attachment part 74 can be molded singly as the housing case 75, leading to a higher degree of freedom in the shape of the sensor attachment part 74. Furthermore, in the retainer 70, the engagement claws 78 of the housing case 75 separate from the retainer main body 72 engage with the edges 77A of the retainer main body 72, so that the housing case 75 is attached to the retainer main body 72. The locking claws 76 of the housing case 75 mate with the peripheral edge 130A of the sensor 130, so that the sensor 130 is attached to the housing case 75. Here, in the retainer 70, since the housing case 75 is separated from the retainer main body 72 and the first connection part 40, the locking claws 76 and the engagement claws 78 are easily molded on the housing case 75.

In the retainer 20 according to the above-described embodiment, the second connection part 60 is integral with the retainer main body 22, but the present disclosure is not limited to this configuration. For example, the second connection part 60 may be formed with a clip 42 like the first connection part 40. In this case, an opening identical in dimensions to the opening 27 is provided to a portion to which the second connection part 60 is provided in the retainer main body 22.

In the retainer 20 according to the above-described embodiment, the sensor attachment part 30 and the retainer main body 22 are integral together and the first connection part 40 is separate from the sensor attachment part 30 and the retainer main body 22, but the present disclosure is not limited to this configuration. For example, the retainer main body 22, the sensor attachment part 30, and the first connection part 40 may be separate from each other. In addition to these, the second connection part 60 may be separate. In this case, the first connection part 40 and the sensor attachment part 30 are later fitted to the retainer main body 22. Thus, an increase in the size of the retainer main body 22 can be suppressed as compared with a case where the retainer main body 22, the sensor attachment part 30, and the first connection part 40 are integral together. In addition, the retainer main body 22, the sensor attachment part 30, and the first connection part 40 can be each molded singly, and thus the retainer main body 22, the sensor attachment part 30, and the first connection part 40 each have a higher degree of freedom in shape.

In the above-described embodiment, the bumper 110 and the sensor 130 are attached to the rear fender of the vehicle body 100 through the retainer 20, but the present disclosure is not limited to this configuration. A sensor different from the radar sensor may be attached to the sensor attachment part 30 of the retainer 20. A bumper different from the rear bumper may be attached to the retainer 20.

In the retainer 20 according to the above-described embodiment, as the blocking mechanism 50, the first ribs 52 are provided to the inner peripheral face 27A of the opening 27 and the second ribs 54 are provided to the outer peripheral face 43A of the insertion part 43, but the present disclosure is not limited to this configuration. For example, the first ribs 52 and the second ribs 54 may be each tapered in the protruding height such that the insertion part 43 of the clip 42 is restrained by the opening 27 as the insertion part 43 is inserted into the opening 27.

Embodiments of the present disclosure have been described above, but the present disclosure is not limited to the above. Thus, in addition to the above, various modifications can be made without departing from the gist of the present disclosure.

Regarding the above embodiments, the following notes are further disclosed.

### Note 1

A bumper retainer according to Note 1 includes: a retainer main body for attaching a bumper to a vehicle body, the retainer main body being made of resin; a sensor attachment part provided on a side in a thickness direction of the retainer main body, the sensor attachment part being integral with or separate from the retainer main body, the sensor attachment part enabling a sensor to be attached to the sensor attachment part; and a connection part protruding from the retainer main body in a direction orthogonal to the thickness direction, the connection part being located on a straight line extending in the thickness direction through the sensor attachment part as viewed counter to the direction in which the connection part protrudes, the connection part being separate from the sensor attachment part, the connection part being connectable to an exterior component.

Note that the thickness direction of the retainer main body is identical to the direction of opening and closing of a pair of molds for molding the retainer main body (including the direction of demolding).

In a case where the retainer main body, the sensor attachment part, and the connection part are integrally molded, since a slider for molding the connection part and the molds interfere with each other, when looking the retainer main body in a counter direction in which the connection part protrudes, the connection part cannot be disposed on the straight line extending in the thickness direction of the retainer main body through the sensor attachment part. For avoidance of the mutual interference between the molds and the slider, it is conceivable that the connection part is disposed at a position out of the above-described straight line. However, in this case, a size of the retainer main body is likely to increase. Changing the position of the connection part is likely to cause a change in the position of a portion, included in the exterior component, to have connection with the connection part. On the other hand, it is conceivable that a change is made in the position of the sensor attachment part with no change in the position of the connection part. However, the position of the sensor attachment part depends on the attachment position of the sensor to the vehicle body, and thus a change in position is difficult.

Thus, in the bumper retainer according to Note 1, in a case where the retainer main body and the sensor attachment part are integral together, the connection part is separate from the sensor attachment part. That is, the connection part is separate from the retainer main body. In such a case where the connection part is separate from the retainer main body and the sensor attachment part as above, the connection part is fixed later to the retainer main part. Thus, an increase in size of the retainer main body can be suppressed as compared with a case where the retainer main body, the sensor attachment part, and the connection part are integral together. In addition, the connection part can be molded singly, leading to a higher degree of freedom in the shape of the connection part.

In the bumper retainer according to Note 1, in a case where the retainer main body and the sensor attachment part are separate from each other, while the retainer main body and the connection part are made integral together, the connection part can be set at a predetermined position. In such a case where the sensor attachment part is separate from the retainer main body as above, the sensor attachment part is fitted later to the retainer main body. Thus, an increase in the size of the retainer main body can be suppressed as compared with a case where the retainer main body, the sensor attachment part, and the connection part are integral together. In addition, the sensor attachment part can be molded singly, leading to a higher degree of freedom in the shape of the sensor attachment part.

Furthermore, in the bumper retainer according to Note 1, in a case where the retainer main body, the sensor attachment part, and the connection part are separate from each other, the connection part and the sensor attachment part are fitted later to the retainer main body. Thus, an increase in the size of the retainer main body can be suppressed as compared with a case where the retainer main body, the sensor attachment part, and the connection part are integral together. In addition, the retainer main body, the sensor attachment part, and the connection part can be each molded singly, and thus the retainer main body, the sensor attachment part, and the connection part each have a higher degree of freedom in shape.

As described above, in the bumper retainer according to Note 1, an increase in the size of the retainer main body can be suppressed as compared with a case where the retainer main body, the sensor attachment part, and the connection part are integral together. In this manner, an increase in the size of the bumper retainer is suppressed, enabling effective use of the space between the vehicle body and the bumper.

### Note 2

A bumper retainer according to Note 2 is the bumper retainer according to Note 1, in which the connection part includes a connection member that is separate from the retainer main body and connects the retainer main body and the exterior component, and the connection member includes a locking part locking with a locked part included in the exterior component; and an engagement part that engages with an engaged part included in the retainer main body.

In the bumper retainer according to Note 2, the engagement part of the connection member, which is separate from the retainer main body, engages with the engaged part included in the retainer main body, so that the connection member is attached to the retainer main body. In addition, the locking part of the connection member locks the locked part included in the exterior component, so that the connection member and the exterior component are connected together. Here, in the above bumper retainer, since the connection member is separate from the retainer main body and the sensor attachment part, the locking part and the engagement part are easily molded on the connection member.

### Note 3

A bumper retainer according to Note 3 is the bumper retainer according to Note 2, further including an opening provided to the retainer main body, the opening allowing the connection member to be inserted into the opening; and a blocking mechanism that prevents the connection member inserted in the opening from rotating.

In the bumper retainer according to Note 3, with the connection member inserted in the opening of the retainer main body, the blocking mechanism prevents the connection member from rotating to the opening. Thus, with the connection member inserted in the opening of the retainer main body, rattling due to rotation of the connection member is prevented.

### Note 4

A bumper retainer according to Note 4 is the bumper retainer according to Note 3, in which the blocking mechanism includes first ribs provided, spaced apart in a circumferential direction, on an inner peripheral face of the opening, first ribs extending from one end toward another end of the opening along an insertion direction of the connection member; and second ribs provided, spaced apart in a circumferential direction, on an outer peripheral face of an insertion part of the connection member, the insertion part being inserted into the opening, the second ribs extending along the insertion direction on a portion on a side counter to the insertion direction of the insertion part, and with the insertion part inserted in the opening, the first ribs are in contact with the outer peripheral face of the insertion part and the second ribs are in contact with the inner peripheral face of the opening.

In the bumper retainer according to Note 4, when the insertion part of the connection member is inserted into the opening of the retainer main body, first, the first ribs contact the outer peripheral face of the insertion part. When the insertion part is inserted into the opening with the contact state kept, the second ribs of the insertion part contact the inner peripheral face of the opening, leading to prevention of the connection member from rotating to the opening. Here, in the above bumper retainer, the connection member is inserted into the opening and then is guided in the insertion direction inside the opening by the first ribs until the second ribs contact the inner peripheral face of the opening. In this state, since the second ribs of the connection member are out of contact with the inner peripheral face of the opening, the insertion force to insert the connection member into the opening can be kept low. That is, the bumper retainer enables insertion of the connection member into the opening with a low insertion force at the beginning of insertion and effective prevention of the connection member from rotating to the opening after insertion.

### Note 5

A bumper retainer according to Note 5 is the bumper retainer according to Note 1, in which the sensor attachment part includes a sensor attachment member that is separate from the retainer main body and allows the sensor to be attached to the retainer main body, and the sensor attachment member includes: a locking part that locks a locked part included in the sensor; and an engagement part that engages with an engaged part included in the retainer main body.

In the bumper retainer according to Note 5, the engagement part of the sensor attachment member, which is separate from the retainer main body, engages with the engaged part included in the retainer main body, so that the sensor attachment member is attached to the retainer main body. In addition, the locking part of the sensor attachment member locks the locked part included in the sensor, so that the sensor is attached to the sensor attachment member. Here, in the above bumper retainer, since the sensor attachment member is separate from the retainer main body and the connection part, the locking part and the engagement part are easily molded on the sensor attachment member.

### Note 6

A bumper retainer according to Note 6 is the bumper retainer according to any one of Notes 1 to 5, in which as viewed counter to the direction in which the connection part protrudes, a direction in which the sensor is attached to the sensor attachment part is different from a direction in which the exterior component is connected to the connection part.

In the bumper retainer according to Note 6, since the sensor attachment part and the connection part are separate from each other, as viewed counter to the direction in which the connection part protrudes, the direction in which the sensor is attached to the sensor attachment part and the direction in which the exterior component is connected to the connection part can be made different from each other. Thus, the attachment direction of the sensor and the connection direction of the exterior component can be optimized.

### Note 7

A bumper retainer according to Note 7 is the bumper retainer according to any one of Notes 1 to 6, in which the bumper is a rear bumper, the sensor is a radar sensor that detects an object approaching the vehicle body from a rear lateral side, and the exterior component is a rear lamp.

The bumper retainer according to Note 7 allows the rear bumper to be attached to the vehicle body through the retainer main body attached to the vehicle body. The radar sensor is attached to the sensor attachment part provided to the retainer main body, so that the radar sensor is attached to the vehicle body. The radar sensor can detect, through the rear bumper, an object approaching the vehicle body from the rear lateral side. The rear lamp to be attached to the vehicle body and the retainer main body are connected through the connection part protruding from the retainer main body. Thus, the gap between the rear lamp and the retainer main body can be controlled.

### Note 8

An attachment structure for a vehicle component according to Note 8 includes a vehicle body; a bumper retainer attached to the vehicle body; a bumper attached to the bumper retainer; a sensor attached to the bumper retainer; and an exterior component attached to the vehicle body, the exterior component being connected to the bumper retainer, in which the bumper retainer includes a retainer main body for attaching the bumper to the vehicle body, the retainer main body being made of resin; a sensor attachment part provided on a side opposite to a side of the vehicle body in a thickness direction of the retainer main body, the sensor attachment part being integral with or separate from the retainer main body, the sensor attachment part having the sensor attached to the sensor attachment part; and a connection part protruding from the retainer main body in a direction orthogonal to the thickness direction, the connection part being located on a straight line extending in the thickness direction through the sensor attachment part as viewed counter to the direction in which the connection part protrudes, the connection part being separate from the sensor attachment part, the connection part having the exterior component connected to the connection part.

Note that the thickness direction of the retainer main body is identical to the direction of opening and closing of a pair of molds for molding the retainer main body (including the direction of demolding).

In the bumper retainer in the attachment structure for a vehicle component according to Note 8, in a case where the retainer main body and the sensor attachment part are integral together, the connection part is separate from the sensor attachment part. That is, the connection part is separate from the retainer main body. In such a case where the connection part is separate from the retainer main body and the sensor attachment part as above, an increase in the size of the retainer main body can be suppressed as compared with a case where the retainer main body, the sensor attachment part, and the connection part are integral together. In addition, the connection part can be molded singly, leading to a higher degree of freedom in the shape of the connection part.

In the bumper retainer in the attachment structure for a vehicle component according to Note 8, in a case where the retainer main body and the sensor attachment part are separate from each other, with the retainer main body and the connection part integral together, the connection part can be set at a predetermined position. In such a case where the sensor attachment part is separate from the retainer main body as above, an increase in the size of the retainer main body can be suppressed as compared with a case where the retainer main body, the sensor attachment part, and the connection part are integral together. In addition, the sensor attachment part can be molded singly, leading to a higher degree of freedom in the shape of the sensor attachment part.

Furthermore, in the bumper retainer in the attachment structure for a vehicle component according to Note 8, in a case where the retainer main body, the sensor attachment part, and the connection part are separate from each other, an increase in the size of the retainer main body can be suppressed as compared with a case where the retainer main body, the sensor attachment part, and the connection part are integral together. In addition, the retainer main body, the sensor attachment part, and the connection part can be each molded singly, and thus the retainer main body, the sensor attachment part, and the connection part each have a higher degree of freedom in shape.

As described above, in the attachment structure for a vehicle component according to Note 8, an increase in the size of the bumper retainer is suppressed as compared with a case where the retainer main body, the sensor attachment part, and the connection part integral together. Thus, the space between the vehicle body and the bumper can be effectively used. The disclosure of Japanese Patent Application No.

2022-106681, filed on Jun. 30, 2022, is incorporated herein by reference in its entirety. All references, patent applications, and technical standards described herein are incorporated herein by reference to the same extent that individual references, patent applications, and technical standards are specifically and individually noted as being incorporated by reference.

1. A bumper retainer comprising:
a retainer main body for attaching a bumper to a vehicle body, the retainer main body being made of resin;
a sensor attachment part provided on a side in a thickness direction of the retainer main body, the sensor attachment part being integral with or separate from the retainer main body, a sensor being configured to be attached to the sensor attachment part; and
a connection part protruding from the retainer main body in a direction orthogonal to the thickness direction, and located on a straight line extending in the thickness direction through the sensor attachment part as viewed counter to a direction in which the connection part protrudes, the connection part being separate from the sensor attachment part and configured to be connectable to an exterior component.

2. The bumper retainer according to claim 1, wherein
the connection part is formed of a connection member that is separate from the retainer main body and configured to connect the retainer main body and the exterior component, and
the connection member includes a locking part that is configured to lock with a locked part where the exterior component is equipped, and an engagement part that engages an engaged part included in the retainer main body.

3. The bumper retainer according to claim 2, further comprising:
an opening provided at the retainer main body, the connection member being inserted into the opening; and
a blocking mechanism that prevents the connection member inserted in the opening from rotating.

4. The bumper retainer according to claim 3, wherein
the blocking mechanism includes:
first ribs provided, to be spaced apart in a circumferential direction, on an inner peripheral face of the opening, the first ribs extending from one end toward another end of the opening along an insertion direction of the connection member; and
second ribs provided, to be spaced apart in a circumferential direction, on an outer peripheral face of an insertion part, of the connection member, to be inserted into the opening, the second ribs extending along the insertion direction on a portion on a side counter to the insertion direction of the insertion part,
wherein in a condition that the insertion part is inserted in the opening, the first ribs contact the outer peripheral face of the insertion part and the second ribs contact the inner peripheral face of the opening.

5. The bumper retainer according to claim 1, wherein
the sensor attachment part is formed of a sensor attachment member that is separate from the retainer main body and is configured to attach the sensor to the retainer main body, and
the sensor attachment member includes a locking part that locks a locked part included in the sensor, and an engagement part that engages an engaged part included in the retainer main body.

6. The bumper retainer according to claim 1, wherein as viewed counter to a direction in which the connection part protrudes, a direction in which the sensor is attached to the sensor attachment part is different from a direction in which the exterior component is configured to be connected to the connection part.

7. The bumper retainer according to claim 1, wherein
the bumper is a rear bumper,
the sensor is a radar sensor that detects an object approaching the vehicle body from a rear lateral side, and
the exterior component is a rear lamp.

8. An attachment structure for a vehicle component, comprising:
a vehicle body;
a bumper retainer attached to the vehicle body;
a bumper attached to the bumper retainer;
a sensor attached to the bumper retainer; and
an exterior component attached to the vehicle body, and connected to the bumper retainer, wherein
the bumper retainer includes:
a retainer main body for attaching the bumper to the vehicle body, the retainer main body being made of resin;
a sensor attachment part provided on a side opposite to a side of the vehicle body in a thickness direction of the retainer main body, the sensor attachment part being integral with or separate from the retainer main body and being attached with the sensor; and
a connection part protruding from the retainer main body in a direction orthogonal to the thickness direction, and located on a straight line extending in the thickness direction through the sensor attachment part as viewed counter to a direction in which the connection part protrudes, the connection part being separate from the sensor attachment part and connected to the exterior component.
